(19) United States
(12) Patent Application Publication
(10) Pub. No.: US 2020/0230746 A1
(43) Pub. Date: Jul. 23, 2020

(54) COMPOSITE COMPONENTS FABRICATED BY IN-SITU REACTION SYNTHESIS DURING ADDITIVE MANUFACTURING

(71) Applicant: ExxonMobil Research and Engineering Company, Annandale, NJ (US)

(72) Inventors: Hyun-Woo Jin, Easton, PA (US); Ning MA, Whitehouse Station, NJ (US)

(21) Appl. No.: 16/739,762

(22) Filed: Jan. 10, 2020

Related U.S. Application Data
(60) Provisional application No. 62/795,083, filed on Jan. 22, 2019.

(51) Int. Cl. B23K 26/354; B33Y 70/10; B23K 26/34; B33Y 10/00; B33Y 80/00

(52) U.S. Cl. CPC B23K 26/354; B33Y 70/10; B33Y 80/00; B33Y 10/00; B23K 26/34

(57) ABSTRACT

The present disclosure relates to reactive manufacturing methods to disperse fine second phase particles within a matrix, and compositions made thereof. Specifically, the reactive manufacturing methods are based on in-situ reaction synthesis during an additive manufacturing (AM) process to fabricate composite components for structural and/or functional applications. The composite components can be particularly useful in oil and gas applications.

### CROSS-REFERENCE TO RELATED APPLICATIONS

This application claims the benefit of U.S. Provisional Application No. 62/795,083, filed on Jan. 22, 2019, the entire contents of which are incorporated herein by reference.

### FIELD

The present disclosure relates to reactive manufacturing methods for dispersing fine second phase particles within a matrix and the compositions made thereof. Specifically, the reactive manufacturing methods are based on in-situ reaction synthesis during additive manufacturing (AM) processes to fabricate composite components for structural and/or functional applications.

### DESCRIPTION

Equipment and structures used in oil and gas operations, for example, are exposed to a wide range of temperatures, stresses, and environmental conditions. Articles made of single composition metallic, ceramic, or polymeric materials often fall short of offering the range of properties desired. Therefore, there is a need to make materials with multiple components in the system, e.g., second phase particles within a matrix, including hard phase particles within a softer matrix.

Composite materials reinforced with second phase particles, including carbides, nitrides, carbon-nitrides, borides, oxides, and combinations thereof, are used for oil and gas industry applications due to combinations of hardness, strength, toughness, cracking resistance, wear/erosion resistance, thermal shock resistance, and corrosion resistance.

In conventional manufacturing processes, the second phase particles in reinforced composites are prepared by directly adding second phase particles (e.g., carbides, borides, oxides, nitrides, carbo-nitrides, and combinations thereof) into the matrix, usually a metallic matrix, followed by exposure to high temperatures (e.g., sintering of powder, thermal spray deposition). In powder metallurgical routes, second phase particles and matrix (e.g., metals/alloys) powders are mixed, pressed into green compacts, and then sintered to form consolidated components. The sintering process requires heating the samples in a furnace for a long time from a few to tens of hours. The second phase particles in the composite components are usually coarse (more than 1 μm diameter), and unevenly distributed, and may decompose during the high temperature exposure. Even new phases (e.g., W₂C, W₃Co₃C eta (η) phase) may form as a decomposition product of the second phase particles (e.g., WC). In addition, the interface between the second phase particles and the matrix is often a potential source of weakness since the surfaces of added second phase particles are usually not clean and are contaminated with impurities. Another drawback related to conventional composite component manufacturing processes involving directly adding hard phase particles into the relatively softer matrix materials is the stringent control required for production processes (e.g., high sintering temperatures) and need for a post-sintering processes (e.g., machining).

Therefore, there is need to fabricate second phase reinforced composite components by additive manufacturing of reactive powders, wire, strips, or combinations thereof. The present disclosure relates to fabrication methods for composite components containing second phases without the necessity to reach the dissolution or melting point of the second phases.

### SUMMARY

The present disclosure relates to a reactive manufacturing method comprising dispersing fine second phase particles within a matrix and compositions made thereof. Specifically, reactive manufacturing methods are based on in-situ reaction synthesis during Additive Manufacturing (AM) processes to fabricate composite components for structural and/or functional applications. With the described fabrication techniques, composite components can be produced with fine (e.g., ≤1 μm grain size) second phase particles dispersed within a ductile matrix.

In one aspect, the present disclosure relates to methods to fabricate second phase reinforced composites including simultaneously additive manufacturing and reactive synthesizing a composite comprising of second phase particles and a metallic matrix, wherein the second phase particles are produced by reactive synthesis during the additive manufacturing.

In some embodiments, the second phase particles of the present disclosure include but are not limited to carbides, nitrides, borides, oxides, carbonitrides, boro-carbides, boro-nitrides and combinations thereof.

In some embodiments, the second phase particles of the present disclosure are spherical particles with a mean diameter in the range of 20 nm to 10 μm, 20 nm to 5 μm, 20 nm to 2 μm, 20 nm to 1 μm, or 50 nm to 500 nm. Mean diameter may be measured using ASTM B822-17.

In some embodiments, the metallic matrix of the present disclosure includes but is not limited to iron-based alloys, steels, nickel-based alloys, cobalt-based alloys, copper-based alloys, aluminum-based alloys, titanium-based alloys, magnesium-based alloys, and combinations thereof.

In some embodiments, the second phase particles of the present disclosure are uniformly dispersed in the metallic matrix and have a clean (e.g., free from additional phases) interfacial structure with the metallic matrix. In other embodiments, the second phase particles are gradiently dispersed in the metallic matrix and have a clean interfacial structure with the metallic matrix.

In some embodiments, the second phase particles of the present disclosure are reactive synthesized using feedstocks during the additive manufacturing process. In one embodiment, the second phase particles are synthesized from a solid feedstock and a gas feedstock. In other embodiments, the second phase particles are synthesized from two or more solid feedstocks.

In some embodiments, the gas feedstocks include but not limited to methane, propylene, and acetylene as the reactive gas.

In some embodiments, the solid feedstocks include but are not limited to powders, wires, or strips. In specific embodiments, the solid feedstocks are selected from ferrotitanium alloy, titanium, boron, graphite carbon, bitumen, bituminous pitch, coke, petroleum coke, ferroboron, and combinations thereof.

In some embodiments, the amount of feedstocks can be adjusted during the additive manufacturing process. In one embodiment, the gradient of the second phase particles dispersed in the metallic matrix is controlled by controlling the amount of feedstocks.

In some embodiments, the additive manufacturing of the present disclosure is laser metal deposition.

In some embodiments, the present disclosure relates to components produced according to the methods discussed herein. In some embodiments, the component comprises the second phase particles that are uniformly dispersed in the metallic matrix and have a clean interfacial structure with the metallic matrix. In other embodiments, the component comprises the second phase particles that are gradiently dispersed in the metallic matrix and have a clean interfacial structure with the metallic matrix.

These and other features of the systems and methods of the subject disclosure will become more readily apparent to those skilled in the art from the following detailed description taken in conjunction with the drawings.

### BRIEF DESCRIPTION OF THE DRAWINGS

FIG. 1 illustrates a fabrication approach to producing a composite with second phase particles embedded in a metallic matrix by reactive synthesizing and additive manufacturing.

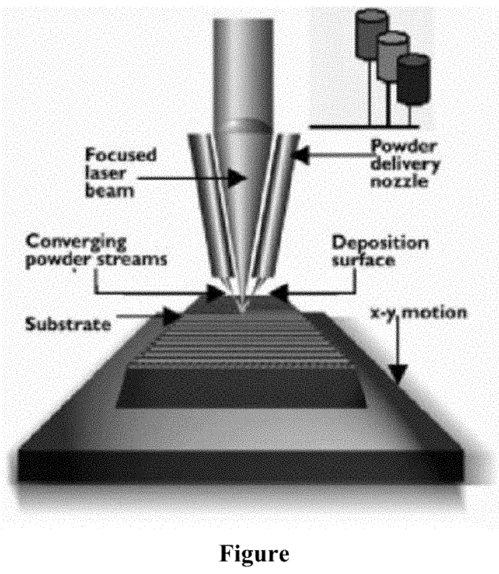

### DETAILED DESCRIPTION

The present description provides reactive manufacturing methods based on in-situ reaction synthesis during additive manufacturing (AM) processes to fabricate composite components for structural and/or functional applications.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

The following terms are used to describe the present disclosure. Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

The articles “a” and “an” as used herein and in the appended claims refer to one or to more than one (i.e., to at least one) of the grammatical object of the article unless the context clearly indicates otherwise. By way of example, “an element” means one element or more than one element.

The phrase “and/or,” as used herein in the specification and in the claims, means “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The phrase “additive manufacturing” (AM) encompasses many technologies including subsets like laser metal deposition (LMD), 3D printing, rapid prototyping (RP), direct digital manufacturing (DDM), layered manufacturing and additive fabrication. Additive manufacturing refers to the process of joining materials to make objects, usually layer upon layer, as opposed to subtractive manufacturing methodologies.

This invention relates to both the methods to fabricate composites by in-situ reaction synthesis during the additive manufacturing (AM) processes and components made thereof.

In one aspect, the present disclosure relates to methods to fabricate second phase reinforced composite including simultaneous additive manufacturing and reactive synthesizing a composite comprising second phase particles and a metallic matrix, wherein the second phase particles are produced by reactive synthesizing during the additive manufacturing.

In one aspect, the present disclosure relates to composite components manufacturing methods combining in-situ reactive synthesis with additive manufacturing. The present disclosure provides a potentially useful manufacturing method in producing composite components consisting of second phase particles and a metallic matrix. The second phases may comprise of carbides, nitrides, borides, oxides, carbonitrides, boro-carbides, boro-nitrides and combinations thereof. The matrix phase may comprise iron-based alloys, steels, nickel-based alloys, cobalt-based alloys, copper-based alloys, aluminum-based alloys, titanium-based alloys, magnesium-based alloys, and combinations thereof.

In one aspect, the second phases can be produced by an in-situ reaction directly during the fabrication or deposition of components using additive manufacturing. In addition, the second phase particles are fine, and uniformly dispersed and have a clean interfacial structure with the metal matrix. For instance, the mean size of the second phase particles can be controlled to be very fine (e.g., below 1 μm or 500 nm) because the second phase particles are formed in-situ and the particle's residence time in the heat source (e.g., laser beam, electron beam, flame, arc, plasma etc.) is only a few miliseconds or less. The dispersion of these fine-grained second phase particles in the matrix leads to improved performance properties of the composite components, including enhanced wear resistance, erosion resistance, yield strength, and toughness by hindering crack propagation.

In one embodiment, the present disclosure provides methods to fabricate the structure of functional components with a second phase particle gradient. The volume fraction of the dispersed second phase particles is controlled by varying the amount of feedstock powder/wire for the in-situ reaction.

One exemplary component of the present disclosure can be a composite material of ceramic grains bonded with metal designed for superior wear resistance via the use of a gradient composition of ceramic grains and metal binder. Controlled variation of the feedstock ratios can be produced through the body cross-section using site-specific changes in the feedstock powder ratios when powder is added to form the composite component. These variations are then locked into place by the additive manufacturing process during which the metal binder is fused. Composite components with gradient composition can provide an optimized solution for step-out erosion/wear resistance where ratios of metal and ceramic powder are varied through the cross-section of the component body. High ceramic compositions are achievable at the working face for enhanced wear/erosion resistance while retaining desirable toughness/ductility with higher metal fraction at the interior. At the same time, these metal additions have been shown to mollify undesirable thermal expansion and brittleness properties inherent in many ceramics. These effects are further shown to be a function of the relative concentration of metal and ceramic.

In addition, the in-situ reactions to synthesize the second phases are exothermic, which provides supplemental heat for the additive manufacturing process and enables composite components to be prepared by simple, lower power additive manufacturing devices.

In some embodiments, the second phase particles in the composite component are synthesized by reactions of a solid constituent with a gas constituent. For instance, TiC reinforced composite components can be prepared by solid-gas reaction using ilmenite powder as the feed material and methane, propylene, and acetylene as the reactive gas.

In some embodiments, a solid-solid reaction may be utilized to synthesize second phases in a composite component by reactions between two or more solid constituents. For example, TiC reinforced composite components can be prepared by reacting agglomerated compound powders of titanium (or titanium alloy), graphite, and other metals (e.g., Ni, Fe etc.). For solid-solid reaction synthesis, the reactive product can be designed and controlled by adjusting the composition of the compound powders for additive manufacturing. The powders used for the current invention may be prepared by simple mechanical pelletization with or without adding a small amount of agglomerant.

In yet another embodiment of the present disclosure, the compound powders may be utilized for solid-solid reaction synthesis during additive manufacturing in order to obtain a composite with improved performance. For instance, a precursor carbonization process may be utilized to produce Ti—Fe—C system compound powders for the fabrication of TiC reinforced composite components. An exemplary raw material for carbonaceous precursor material can be bitumen or petroleum coke. The bitumen can be mixed with ferrotitanium powder. The mixture of ferrotitanium powder and bitumen can be heated up to elevated temperature (e.g., ≥500-600° C.) to form compound powders. Then, the TiC-Fe composite components can be synthesized and fabricated by additive manufacturing using the compound powder.

In an exemplary embodiment, a TiB₂-Fe composite component can be produced in two different ways. The first one consists of synthesizing TiB₂ through the reaction of a ferrotitanium alloy with elemental boron and depositing the reacted products by additive manufacturing. When the chemical composition is adjusted so that the [B]/[Ti] atomic ratio is 2.0, the exothermic reaction that occurs between reactants can be represented by the following reaction 1:

FeTi+Ti+4 B→2 TiB₂+Fe [1]

In another exemplary embodiment TiB₂ particles can be synthesized by melting a ferrotitanium and ferroboron mixture. When the constituents form a mixture in which the [B]/[Ti] atomic ratio is 2.0, the reaction that occurs can be represented by the following reaction 2:

FeTi+Ti+4 FeB→2 TiB₂+5 Fe [2]

The temperature necessary to initiate the exothermic reaction is 675° C. and the temperature to complete the reaction is above 1700 ° C. Temperature within plasma greatly exceeds the reaction temperatures.

In another exemplary composite component/feedstock, carbide-based composite components can be fabricated using reactive powders comprising ferrotitanium and graphite carbon as the following reaction 3:

FeTi+Ti+2 C→2 TiC+Fe [3]

The microstructure of these components may consist of alternating TiC-rich and TiC-poor layers of different hardness. These layers can be modified by changing the composition of reactive powders and/or fabrication conditions. The composite components may contain fine and rounded TiC particles.

The reactive powders for the fabrication of carbide-reinforced composite can be one or more combinations of the following:
i) mixtures of metal and carbonaceous powders (e.g., graphite, bitumen, coke, petroleum coke)
ii) agglomerated metal and carbonaceous powders,
iii) metal-coated/clad carbonaceous powders, and/or
iv) carbonaceous coated metal powders.

The reactive powders can be prepared by using an agglomeration technique including but not limited to mechanical agglomeration or spray drying. These powders, sorted in adequate size fractions, can be sprayed with additive manufacturing equipment under ambient atmosphere or special gas environment (e.g., carbonaceous, nitrogen). A component consisting of overlapping lamellae or layer is progressively formed. Upon impinging the substrate or underlying layers of additively manufactured deposits, the components undergo rapid solidification which further enhances the microstructure of the components as opposed to the components of the same composition solidified in a furnace.

In some embodiments, TiB₂-containing composite components can be fabricated by using the reactive wires/strips. This technology may offer considerable advantages in cost and production rate. The exemplary reactive wires/strips may consist of basically the same reagents as those used in reactive powders (e.g., FeTi and B, or FeTi, and FeB in case of TiB₂-based composite). These reactive wires may comprise metal sheaths that wrap around densified cores of the reagents or metal wires coated with reagents.

The present disclosure can be fabricated by various AM processing techniques including but not limited to laser metal deposition (LMD), directed energy deposition (DED), and powder bed fusion (PBF). For Example, the Figure illustrates a method of producing the composite using LMD, in which powder delivery nozzles deliver the gas and/or solid powder to the tip of the laser beam and on the surface of the substrate, and an in-situ reaction would form second phase particles during the deposition process to form a composite. LMD uses a laser beam to form a melt pool on a metallic substrate, into which the powder is fed. The powder melts to form a deposit that is fusion bonded to the substrate. Applications of LMD include the repair of worn components, performing near net shape freedom builds directly from CAD file, and the cladding of materials.

Directed energy deposition is an additive manufacturing process in which focused thermal energy (e.g., laser, plasma arc, electron beam) is focused to fuse the materials being deposited. Powder bed fusion is an additive manufacturing process in which thermal energy (e.g., laser, plasma arc, electron beam) selectively fuses regions of a powder bed. In some embodiments, the commercialized system using a LMD process is called laser engineered net shaping (LENS, similar to what is shown in the Figure). A typical LENS system is equipped with an energy variable laser head with 3 kW peak output. The powder feeders can create powder streams and different powders can be delivered to the point of deposition simultaneously. The focused laser beam melts the surface of the target and generates a small molten pool that may range from 0.005 to 0.04 inches in thickness and 0.04 to 0.160 inches in width, which results in a heat affected zone (HAZ) ranging from 0.005 to 0.025 inches. Due to the small melt pool, the deposits cool very fast (up to 10,000° C./s), which generates very fine grain structures that may be comparable with wrought product. A variety of materials have been successfully deposited using this process, including stainless steel, tool steels, nickel alloys, titanium alloy and ceramics. Work can be performed utilizing a shielding gas system similar to the gas metal arc welding process.

In some embodiments, the second phase particles can have a residence time for exposure to a heat source of less than 0.5 seconds, such as less than 0.1, 0.05, 0.01, or even 0.005 seconds.

In some embodiments, the second phase particles are uniformly dispersed in the metallic matrix and have a clean interfacial structure with the metallic matrix. In other embodiments, the second phase particles are gradiently dispersed in the metallic matrix and have a clean interfacial structure with the metallic matrix.

In some embodiments, the second phase particles of the present disclosure are reactive synthesized using feedstocks during the additive manufacturing process. In some embodiments, the second phase particles are synthesized from a solid feedstock and a gas feedstock. In other embodiments, the second phase particles are synthesized from two are more solid feedstocks.

In some embodiments, the gas feedstocks include but are not limited to methane, propylene, and acetylene as the reactive gas.

In some embodiments, the solid feedstocks include but are not limited to powders, wires, or strips. In specific embodiments, the solid feedstocks are selected from ferrotitanium alloy, titanium, boron, graphite carbon, bitumen, bituminous coke, petroleum coke, ferroboron, and combinations thereof.

In some embodiments, the amount of feedstocks can be adjusted during the additive manufacturing process. In some embodiments, the gradient of the second phase particles dispersed in the metallic matrix is controlled by controlling the amount of feedstocks.

In some embodiments, the additive manufacturing of the present disclosure is laser metal deposition.

In some embodiments, the present disclosure relates components produced according to the methods discussed herein. In one embodiment, the component comprises the second phase particles uniformly dispersed in the metallic matrix and have a clean interfacial structure with the metallic matrix. In other embodiment, the component comprises the second phase particles gradiently dispersed in the metallic matrix and have a clean interfacial structure with the metallic matrix.

These and other features of the systems and methods of the subject disclosure will become more readily apparent to those skilled in the art from the following detailed description taken in conjunction with the drawings.

It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

1. A method of fabricating a composite material comprising:
performing simultaneous additive manufacturing and reactive synthesis to produce a composite material comprising second phase particles and a metallic matrix, wherein the second phase particles are produced by reactive synthesis during the additive manufacturing.

2. The method of claim 1, wherein the second phase particles comprise at least one compound selected from the group consisting of carbides, nitrides, borides, oxides, carbonitrides, boro-carbides, boro-nitrides, and combinations thereof.

3. The method of claim 1, wherein the second phase particles have a mean diameter in the range of 100 nm to 20 μm, wherein mean particle diameter is measured according to ASTM B822-17.

4. The method of claim 3, wherein the second phase particles have a mean diameter in the range of 500 nm to 10 μm, wherein mean particle diameter is measured according to ASTM B822-17.

5. The method of claim 1, wherein the metallic matrix comprises a material selected from the group consisting of iron-based alloys, steels, nickel-based alloys, cobalt-based alloys, copper-based alloys, aluminum-based alloys, titanium-based alloys, magnesium-based alloys, and combinations thereof.

6. The method of claim 1, wherein the second phase particles are uniformly dispersed in the metallic matrix and have a clean interfacial structure with the metallic matrix.

7. The method of claim 1, wherein the second phase particles are produced by contacting a solid feedstock with a gas feedstock.

8. The method of claim 1, wherein the second phase particles are produced by contacting a solid feedstock with another solid feedstock.

9. The method of claim 7 or 8, further comprising controlling the amount of one or more feedstocks.

10. The method of claim 8, wherein the feedstocks are solid powders.

11. The method of claim 10, wherein the solid powders are prepared by mechanical pelletization.

12. The method of claim 8, wherein the feedstocks are reactive wires or strips.

13. The method of claim 9, wherein the feedstocks are adjusted during the reactive synthesizing to form a gradient of second phase particles in the metallic matrix.

14. The method of claim 9, wherein the feedstocks are selected from a group consisting of ferrotitanium alloy, titanium, and boron.

15. The method of claim 9, wherein the feedstocks are selected from a group consisting of ferrotitanium alloy, titanium, and ferroboron.

16. The method of claim 9, wherein the feedstocks are selected from a group consisting of ferrotitanium alloy, titanium, graphite carbon, and bitumen.

17. The method of claim 1, wherein the additive manufacturing comprises laser metal deposition.

18. A component comprising the composite produced according to the method of claim 1.

19. A component comprising the composite produced according to the method of claim 1, wherein the second phase particles are gradiently dispersed in the metallic matrix.
